(19) United States
(12) Patent Application Publication
(10) Pub. No.: US 2004/0107204 A1
(43) Pub. Date: Jun. 3, 2004

(54) File management apparatus

(75) Inventor: Tadashi Sakamoto, Tokyo (JP)

Correspondence Address: BURNS, DOANE, SWECKER & MATHIS, L.L.P., P.O. Box 1404, Alexandria, VA, 22313-1404, US

(73) Assignees: RENESAS TECHNOLOGY CORPORATION; RENESAS SOLUTIONS CORPORATION

(21) Appl. No.: 10/610,923

(22) Filed: Jul. 2, 2003

(30) Foreign Application Priority Data
Dec. 2, 2002 (JP) 2002-350123

(51) Int. Cl. G06F 17/00

(52) U.S. Cl. 707/101

(57) ABSTRACT

In a processor (10), an index creating unit 14 creates an index indicating a piece of file management information about a target file to be read from a file name specifying the target file to be read by using a function representing a one-to-one correspondence between file names and indexes. An index and file management information associating unit (15) reads apiece of file management information corresponding to the index created by the index creating unit (14) from a file management information array 13 in which plural pieces of file management information are aligned in ascending order of corresponding indexes, and then acquires a position where the target file to be read specified by the read piece of file management information is stored in a storage unit (30).

### BACKGROUND OF THE INVENTION

1. Field of the Invention

The present invention relates to a file management apparatus disposed within electrical equipment having a storage device, for searching for a file in response to a request.

2. Description of Related Art

As a file searching method which file management systems for use in an information processing device employ, there has been provided a sequential access method of sequentially accessing files from their heads in the order in which these files are stored until reaching a target file. For example, a file management system employed in MS-DOS (registered trademark) uses a file allocation table method of performing a sequential access. However, a drawback of the sequential access method is that when a lot of files are stored in the storage unit, it takes much time to reach the target file.

As a method of carrying out searching at a high speed, there is a hash method of converting a search key for the target file into an address by using a hash function. According to the hash method, it is possible to reach the target file by using a hash function used for registering the target file when searching for the target file. For example, in accordance with a technology as disclosed in Japanese patent application publication (TOKKAI) No. 2000-357115, a file name code is converted, as a search key, into an address by using a hash function, and the conversion result is then provided for searching of the target file. However, the conversion result may agree with another conversion result because the hash function is a function representing a multi-to-one correspondence between search keys and addresses. To solve this problem, in accordance with the technology as disclosed in the above-mentioned reference, assuming that files having the same computation result of the hash function belong to a group (i.e., a directory), files that belong to the directory are sequentially accessed so that a desired file can be found out.

However, when the number of files having the same computation result of the hash function increases, it is predicted that dependence on the sequential access increases and therefore the time required to reach the target file becomes long.

Recent years have seen various types of electrical equipment provided with a hard disk or another storage unit, in which files stored in the hard disk or the storage unit are processed. Such various types of electrical equipment include electrical equipment that handles music, moving pictures and sounds, or images. Such electrical equipment needs to search for a target file to be played back as fast as possible without causing user discomfort from the viewpoint of its properties.

### SUMMARY OF THE INVENTION

The present invention is proposed to solve the above-mentioned problem, and it is therefore an object of the present invention to provide a file management apparatus that can search for a target file at a high speed regardless of the number of files stored in a storage unit.

In accordance with the present invention, there is provided a file management apparatus including an index creating unit for creating an index indicating file management information that specifies a position where a target file to be read is stored in a storage unit from the target file's name by using a function representing a one-to-one correspondence between file names and indexes, a storage access control unit for, to read the target file from the storage unit, reading a piece of file management information corresponding to the index created by the index creating unit from a file management information array in which plural pieces of file management information are aligned in order of corresponding indexes, and for acquiring a position where the target file specified by the read piece of file management information is stored in the storage unit. In other words, the index created by the index creating unit indicates a position within the file management information array where a corresponding piece of file management information about the target file to be read is stored. Thus the electrical equipment can acquire the file management information about the target file at once based on the index without searching for it through the file management information array. Therefore, the electrical equipment can search for the target file at a high speed regardless of the number of files stored in the storage unit. In addition, because the electrical equipment uses the function representing a one-to-one correspondence between file names and indexes, it can prevent creation of an indeterminate index from a corresponding file name and a collision between a created index and any other index. Therefore, the electrical equipment need not perform complementary processing by using another access method and can surely search for the target file at a high speed.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing a part of electrical equipment provided with a file management apparatus according to embodiment 1 of the present invention;

FIG. 2 is a diagram showing a principle behind the file management apparatus according to embodiment 1;

FIG. 3 is a diagram showing a series of pieces of file management information used by the file management apparatus according to embodiment 1;

FIG. 4 is a diagram showing a principle behind a file management apparatus according to embodiment 2;

FIG. 5 is a diagram showing a series of pieces of file management information used by the file management apparatus according to embodiment 2;

FIG. 6 is a block diagram showing an index generation unit that is suitably used in the file management apparatus according to embodiment 2 of the present invention;

FIG. 7 is a block diagram showing a part of electrical equipment provided with a file management apparatus according to embodiment 3 of the present invention;

FIG. 8 is a diagram showing a series of pieces of file name use status information and a series of pieces of file management information used by the file management apparatus according to embodiment 3;

FIG. 9 is a block diagram showing a part of electrical equipment provided with a file management apparatus according to embodiment 4 of the present invention;

FIG. 10 is a diagram for explaining use of a series of pieces of file name use status information in the file management apparatus according to embodiment 4; and

FIG. 11 is a diagram showing a principle behind the file management apparatus according to embodiment 4.

### DETAILED DESCRIPTION OF THE PREFERRED EMBODIMENTS

Hereafter, various embodiments in accordance with the present invention will be explained with reference to the accompanying drawings. Embodiment 1.

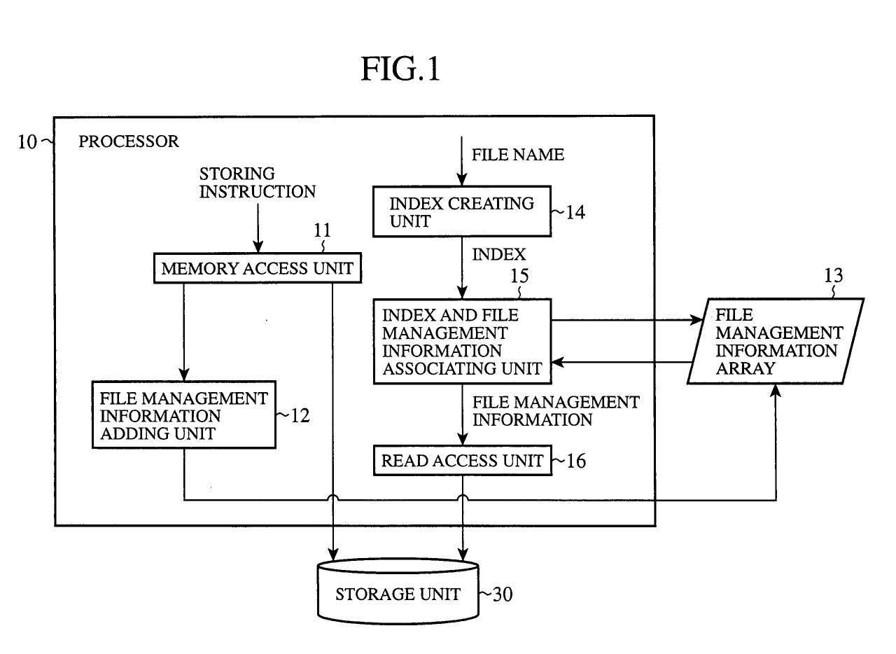

FIG. 1 is a block diagram showing a part of electrical equipment provided with a file management apparatus according to embodiment 1 of the present invention. This electrical equipment has a processor 10 that functions as the file management apparatus and a storage unit 30 for storing electronic data. The electrical equipment to which the present invention can be applied can be any electrical equipment having a storage unit. For example, the electrical equipment can be any one of an audio player, a video player, an electronic album, and a digital still camera.

For the sake of convenience, the processor 10 is divided by function, i.e., executable module into a storage access unit 11, a file management information adding unit 12, an index creating unit 14, an index and file management information associating unit (i.e., a storage access control unit) 15, and a read access unit (i.e., the storage access control unit) 16.

The storage unit 30 is a storage unit, such as a hard disk, a memory card, or a memory stick, which can fixedly store electronic data and which preferably has an ability of storing files of different sizes. For example, when the electrical equipment is an audio player, a video player or an electronic album, music, moving pictures and sounds, or image files are stored in the storage unit 30.

The electrical equipment according to this embodiment has other components for its intended use. For example, when the electrical equipment is an audio player, it has various components for playing back music based on a file read from the storage unit 30. Such components are not shown in the figure.

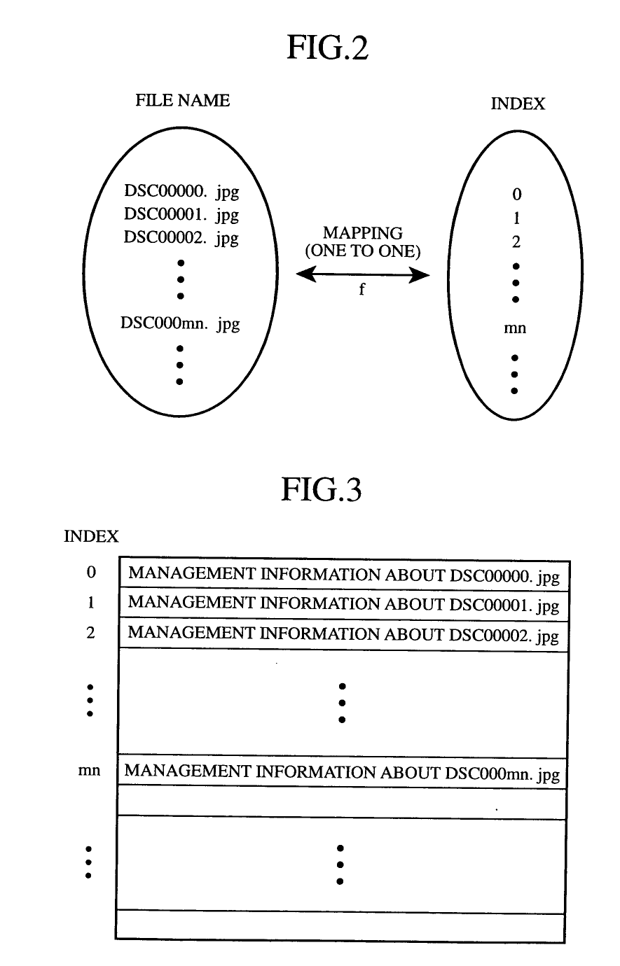

FIG. 2 is a diagram showing a principle behind the file management apparatus according to embodiment 1. The electrical equipment according to this embodiment uses a naming rule for regularly naming of files as illustrated in FIG. 2 in the example of FIG. 2, each file name has a prefix “DSC”, a 5-digit number and a suffix (i.e., a file identifier). For example, when the electrical equipment is a digital still camera, every time when it takes a picture, the electrical equipment adds 1 to the number included in the file name having the largest number which is selected from among file names that have already been used, and then assigns the addition result to the number included in the file name of a newly-created file. In other words, every time when the electrical equipment newly creates a file, a file name is assigned, as the name of the latest file, to the newly-created file in such a manner that the already-used file names will be “DSC00000.jpg”, “DSC00011.jpg”, “DSC00002.jpg”, . . . . The electrical equipment according to this embodiment works based on the premise that the already-created files have file names that are given in a fixed pattern as previously explained. It is essential only that file names are given to the already-created files in a specific pattern, and need not be given to the already-created files in the order in which they are created or retrieved into the electrical equipment. In addition, instead of creating the file name of a file that is to be stored therein, the electrical equipment can allow the user who tries to make the file store in the electrical equipment to determine the file name.

When reading a specific file from the storage unit, the electrical equipment uses the fourth and fifth characters of the specific file's name as an index (which will be described below) for reading the file. In other words, the electrical equipment uses a function f of extracting the fourth and fifth characters from the specific file's name and defining them as an index, just as they are. This function f thus maps an input file name into a uniquely defined index. As can be seen from FIG. 2, the inverse of this function f provides Os as some upper digits for an input index so as to create a 5-digit number, and adds the prefix “DSC” and a suffix to the numerical value. In other words, this inverse function acquires a uniquely defined file name from an index applied thereto. Therefore, there is a one-to-one correspondence between file names and indexes.

Next, an operation of the processor 10 will be explained with reference to FIG. 1. The processor 10 executes the following processes according to a software program. In response to an instruction from a user to store a file which is created by the electrical equipment or which is retrieved into the electrical equipment from outside the electrical equipment, the storage access unit 11 of the processor 10 stores the file in the storage unit 30. The storage access unit 11 further notifies information including the file name and size of the file, the date of creating the file, the position where the file is stored (e.g., a cluster number when the storage unit 30 is a hard disk), file attributes, and other descriptions to the file management information adding unit 12. The storage access unit 11 can automatically provide a file name to the file. As an alternative, the user can provide a file name to the file.

The file management information adding unit 12 adds the information notified thereto from the storage access unit 11, as file management information used to manage a corresponding file stored in the storage unit 30, to a series of pieces of file management information (referred to as a file management information array from here on) 13. While the processor 10 is used, this file management information array 13 is stored in a backup storage unit (e.g., a built-in storage unit within the processor 10 or a random-access memory disposed as a peripheral device) not shown in the figure so that the processor 10 can promptly access the file management information array 13. When the processor 10 is started up, the file management information array 13 is transferred from a fixed storage unit (which can be the storage unit 30, or can be another storage unit not shown in the figure) to the backup storage unit. After that, at an appropriate time, the file management information array 13 is transferred from the backup storage unit to the fixed storage unit so that it is fixedly updated and stored.

The file management information array 13 has one or more pieces of management information about one or more files, as shown in FIG. 3. Each number indicating the position where a corresponding piece of file management information included in the file management information array 13 is stored is an index. In the file management information array 13, all pieces of file management information are aligned in ascending order of numbers represented by corresponding indexes. For example, the management information about the file specified by the file name “DSC00000.jpg” is stored at the position identified by the index 0. Therefore, when reading a certain file, by acquiring an index specifying the file, the electrical equipment can access file management information corresponding to the index at once, and can further access the desired file by acquiring the position where the desired file is stored from the file management information.

When adding a piece of file management information to the file management information array 13, the file management information adding unit 12 applies the function f (see FIG. 2) to a corresponding file name so as to create an index. For example, the file management information adding unit 12 acquires the index 1 from the file name “DSC00001.jpg”. The file management information adding unit 12 then adds a corresponding piece of file management information about the file to a position specified by the index within the file management information array 13.

On the other hand, when a user wants to retrieve a file from the storage unit, the user can specify the file's name by using a man-machine interface not shown in the figure. The electrical equipment notifies the file name to the index creating unit 14. In response to this notification, the index creating unit 14 applies the function f to the file name so as to create an index, and then notifies the index to the index and file management information associating unit 15.

The index and file management information associating unit 15 reads file management information corresponding to the target file from the position specified by the index within the file management information array 13, and notifies the file management information to the read access unit 16. By using a description indicating the position where the file is stored within the file management information, the read access unit 16 reads the target file from the storage unit 30. Thus, the electrical equipment can apply the file to its intended use.

As mentioned above, in accordance with this embodiment 1, the index creating unit 14 creates an index from a file name identifying a target file to be read by using a function f representing a one-to-one correspondence between file names and indexes. In the file management information array 13, all pieces of file management information are aligned in ascending order of corresponding indexes. In other words, the index created by the index creating unit 14 indicates a position within the file management information array 13 where a corresponding piece of file management information about the target file to be read is stored. The electrical equipment can acquire the corresponding piece of file management information about the target file at once based on the index without searching for it through the file management information array 13.

In accordance with this embodiment 1, unlike a file allocation table method or another sequential access method for MS-DOS, it is not necessary to trace stored files one after another so as to search for the target file. Furthermore, unlike a random access method, it is not necessary to search for the corresponding piece of file management information by using the index. Therefore, the electrical equipment can search for the target file at a high speed regardless of the number of files stored in the storage unit 30.

In addition, because the electrical equipment uses the function f representing a one-to-one correspondence between file names and indexes, it can prevent creation of an indeterminate index from a file name and a collision between a created index and any other index. Therefore, the electrical equipment need not perform complementary processing by using another access method and can surely search for the target file at a high speed.

As mentioned above, because the electrical equipment uses the simple function f of assigning a part of the file name extracted from the file name to an index, just as it is, the load on the processor 10 can be reduced. However, in accordance with the present invention, the function f and the created index are not limited to such simple ones. As an alternative, another complex one-to-one correspondence function can be used. Embodiment 2.

Next, a description will be made as to embodiment 2 of the present invention.

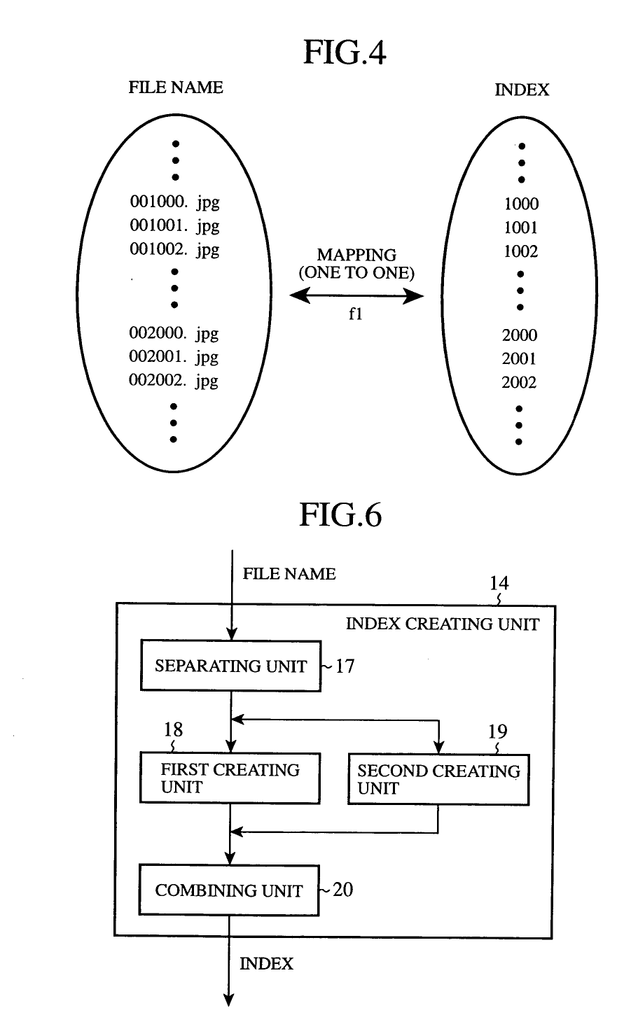

FIG. 4 shows a principle behind a file management apparatus according to embodiment 2 of the present invention. Electrical equipment equipped with the file management apparatus according to this embodiment uses a naming rule for regularly naming of files as illustrated in FIG. 4. In the example of FIG. 4, each file name has a 6-digit number and a suffix (i.e., a file identifier which can be “jpg” concretely).

Furthermore, for the convenience of classification for users, the first several digits (e.g., the first three digits) of each file name can be a temporary directory's name and remaining several digits (e.g., three digits) can be a temporary file's name (i.e., apart indicating a corresponding file itself within the directory). In this case, it can be assumed that each file name, as well as a corresponding file itself, are created according to a method of representing a directory where the file is stored. A user who tries to make the file management apparatus store the file can determine the file name. The electrical equipment according to this embodiment works based on the premise that already-created files have file names that are given in a fixed pattern and the user classifies the file names by using temporary directories.

When reading a specific file from a storage unit, the electrical equipment uses the third through sixth characters of the specific file's name as an index for reading the target file. In other words, the electrical equipment uses a function f1 of extracting the third through sixth characters from the specific file's name and defining them as an index, just as they are. This function f1 thus maps a file name into a uniquely defined index. As can be seen from FIG. 4, the inverse of this function f1 provides Os as some upper digits for an input index so as to create a 6-digit number, and adds a suffix to the numerical value. In other words, this inverse function acquires a uniquely defined file name from an index applied thereto. Therefore, there is a one-to-one correspondence between file names and indexes.

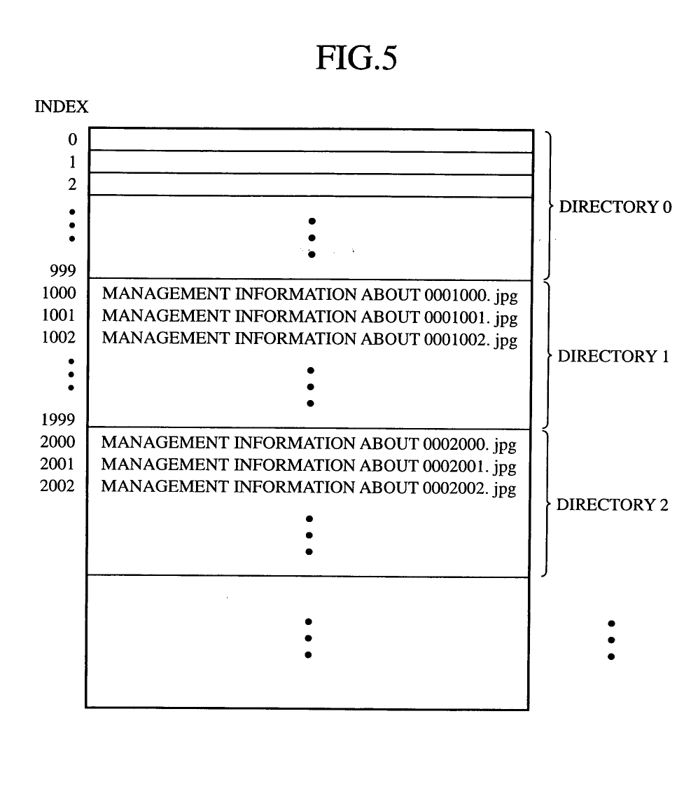

As shown in FIG. 5, a file management information array according to this embodiment can be divided into a plurality of directories. 1000 pieces or less (000 to 999) of temporary files are assigned to each directory. Each 4-digit index indicates a position within the file management information array where a corresponding piece of file management information is stored. In other words, all pieces of file management information are aligned within the file management information array in ascending order of corresponding indexes.

Even the electrical equipment of this embodiment 2 can use a processor 10 and a storage unit 30 as shown in FIG. 1. In the explanation of the operation of the processor 10 of embodiment 1 with reference to FIG. 1, the function f (see FIG. 2) can be replaced by the function f1 (see FIG. 4), so that the operation of the processor 10 of embodiment 2 can be easily understood.

An index creating unit 14 can be modified as shown in FIG. 6. The index creating unit 14 shown in FIG. 6 is divided by function, i.e., executable module into a separating unit 17 (i.e., a first extracting unit and a second extracting unit), a first creating unit 18, a second creating unit 19 and a combining unit 20, for convenience sake.

Next, an operation of the index creating unit 14 of FIG. 6 will be explained. The processor 10 performs the following operation according to a software program. When a user tries to make the electrical equipment read a certain file, he or she specifies the file's name using a man-machine interface not shown in the figure. The file name is notified to the index creating unit 14. In response to this notification about the file name, the separating unit 17 separates the file name into a first portion and a second portion. The first portion is a portion (i.e., a part indicating a corresponding temporary directory's name) that indicates a directory in which the target file to be read is stored, and the second portion is a temporary file's name (i.e., a part indicating the corresponding file itself within the directory). In other words, in the above-mentioned example the first three digits of the 6-digit number included in the file name are the first portion and the remaining three digits are the second portion.

The first portion of the file name is processed by the first creating unit 18. The first creating unit 18 creates a base position of the directory from the first portion by using a function representing a one-to-one correspondence between first portions and directory base positions. For example, when the numerical value of the lowermost digit of the first portion indicates the directory, the first creating unit 18 can multiply the numerical value by a maximum number of files that can be stored in the directory and can define the multiplication result as the base position of the directory. In other words, when the file name is “002001.jpg”, the first creating unit 18 acquires 2,000 as the base position of the directory “2” corresponding to “002” that is the first portion by multiplying 2 by 1,000.

The second portion of the file name is processed by the second creating unit 19. The second creating unit 19 creates an index element from the second portion by using a function representing a one-to-one correspondence between second portions and index elements. For example, the second creating unit 19 can define the second portion as the index element, just as it is. In other words, when the file name is “002001.jpg”, the second creating unit 19 defines “001” that is the second portion as the index element, just as it is.

The combining unit 20 combines the base position and the index element so as to create an index. For example, the combining unit 20 can only sum the base position and the index element so as to acquire an index. In other words, when the file name is “002001.jpg”, an index “2001” is consequentially acquired. When thus acquiring an index, the combining unit 20 of the index creating unit 14 notifies the index to the index and file management information associating unit 15.

The electrical equipment thus creates an index for reading the target file. Even when a file management information adding unit 12, which is used when storing a file in the storage unit 30, adds a piece of file management information to the file management information array 13, the file management information adding unit 12 creates an index from the file name, as in the above-mentioned case.

The functions that the first creating unit 18 and the second creating unit 19 use and the created index are simple. However, in accordance with the present invention, the functions are not limited to such simple ones. As an alternative, another complex one-to-one correspondence function can be used.

As mentioned above, in accordance with this embodiment 2, the index creating unit 14 creates an index from a file name indicating a target file to be read by using a function representing a one-to-one correspondence between file names and indexes. Therefore, the electrical equipment can acquire a piece of file management information about the target file at once based on the index without searching through the file management information array 13. As a result, the electrical equipment can search for the target file at a high speed regardless of the number of files stored in the storage unit 30. In addition, because the electrical equipment uses the function representing a one-to-one correspondence between file names and indexes, it can prevent creation of an indeterminate index from a corresponding file name and a collision between a created index and any other index. Therefore, the electrical equipment need not perform complementary processing by using another access method and can surely search for the target file at a high speed.

In addition, in accordance with this embodiment, the file management apparatus can classify files into a plurality of directories by using their file names. As previously mentioned, the file management apparatus can create an index by extracting a plurality of portions from an input file name, and applying a function to each of these portions so that the index complies with plural pieces of file management information that can be aligned in an arbitrary arrangement within the file management information array 13.

This embodiment is based on a 1-layer directory format in which files can exist in each of a plurality of directories in a single-level hierarchy. As an alternative, this embodiment can be based on a multilevel directory format in which lower-level directories can exist in each directory. For example, by assigning the first three digits of an input file name to a first-level directory's name, the second three digits of the input file name to a second-level directory's name, and a multilevel hierarchy of directories can be implemented. In this case, the index creating unit 14 includes a plurality of creating units for applying their respective functions to a plurality of portions of the input file name.

Furthermore, in accordance with this embodiment, a maximum number of files that can be stored in each directory can be a fixed number, e.g., 1,000, as previously mentioned. As an alternative, it is possible to limit this maximum allowable number of files to a smaller one. By preparing a table having a list of different numbers respectively corresponding to a plurality of directories, a plurality of different maximum allowable numbers of files can be arbitrarily assigned to the plurality of directories, respectively.

Embodiment 3.

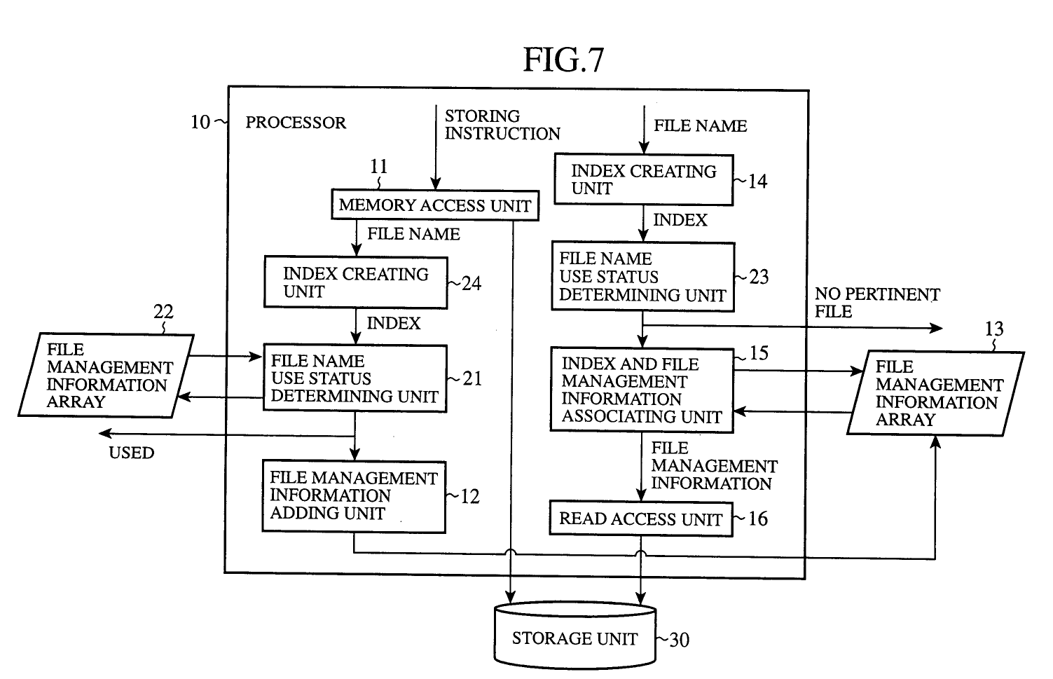

FIG. 7 is a block diagram showing a part of electrical equipment provided with a file management apparatus according to embodiment 3 of the present invention. A processor 10 that is the file management apparatus of FIG. 7 differs from the processor 10 of FIG. 1 according to embodiment 1 in that the process 10 of this embodiment includes a file name use status determining unit 21, another file name use status determining unit 23, and an index creating unit 24 (i.e., a second index creating unit). When the processor 10 newly stores a file in a storage unit 30, the file name use status determining unit 21 determines whether or not the file's name given by a user has already been used (i.e., whether or not the file having the file name has already been stored in the storage unit 30). On the other hand, the other file name use status determining unit 23 determines whether or not the file name of the file that the user tries to use has already been used.

Next, an operation of this processor 10 will be explained. The processor 10 carries out the following operation according to a software program. In response to a storing instruction from a user to store a file which is created by the electrical equipment or which is retrieved into the electrical equipment from outside the electrical equipment, a storage access unit 11 notifies the file's name specified by the storing instruction to the index creating unit 24. It can be assumed that this notification about the file name is an inquiry about whether or not the file name of the target file to be inquired has already been used in the storage unit 30. In response to the notification about the file name, the index creating unit 24 creates an index from the file name by using a function representing a one-to-one correspondence between file names and indexes, and then notifies the index to the file name use status determining unit 21. The function used can be either the function f explained in Embodiment 1 or the function f1 explained in Embodiment 2, or can be a function of another type.

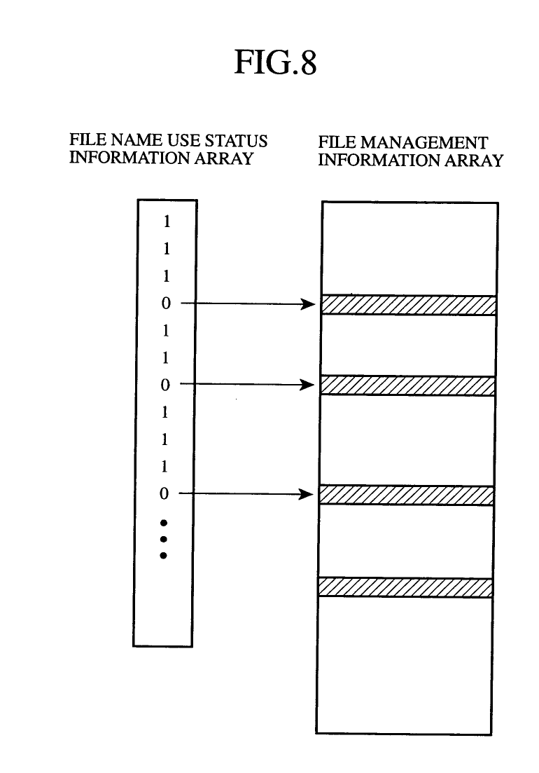

When receiving the index, the file name use status determining unit 21 determines what use status a piece of file name use status information corresponding to the index received from the index creating unit 24 indicates within the file name use status information array 22 by referring to the file name use status information array 22. As shown in FIG. 8, the file name use status information array 22 is a series of plural pieces of binary file name use status information, for example, and they are aligned in ascending order of corresponding indexes and each piece of file name use status information indicates whether or not a corresponding file name has already been used. The position where the corresponding piece of file name use status information is placed within the file name use status information array 22 is specified by the index. When the file name use status information is “1”, the corresponding file name has already been used (i.e., the file having the file name has already been stored in the storage unit 30). In contrast, when the file name use status information is “0”, the corresponding file name is unused (i.e., the file having the file name does not exist in the storage unit 30). Each hatched file management information within the file management information array 22 shown in the figure indicates that no corresponding file exists.

While the processor 10 is used, the file name use status information array 22 is stored in a backup storage unit not shown in the figure (e.g., a built-in storage unit within the processor 10 or a random-access memory disposed as a peripheral device) so that the processor 10 can promptly access it, like the above-mentioned file management information array 13. When the processor 10 is started up, the file name use status information array 22 is transferred from a fixed storage unit (which can be the storage unit 30, or can be another storage unit not shown in the figure) to the backup storage unit. After that, at an appropriate time, the file name use status information array 22 is transferred from the backup storage unit to the fixed storage unit so that it is fixedly updated and stored.

By preparing such the file name use status information array 22 in advance, when trying to newly store a file in the storage unit 30, the processor can easily determine whether or not the file name that is to be given to the file has already been used (i.e., whether or not the file having the file name has already been stored in the storage unit 30) by using the index. The file name use status determining unit 21 generates and outputs a signal indicating “used” when determining that the file name to be determined has already been used (i.e., that the corresponding piece of file name use status information is “1”). The man-machine interface not shown of the electrical equipment urges the user to specify another file name in response to the signal indicating “used”. For example, a display unit or speaker is made to display or speak “The file name has already been used. Please specify another file name.” so as to urge the user to specify another file name. Then the user specifies another file name, and the index creating unit 24 and the file name use status determining unit 21 repeatedly carry out the process of determining the use status of the other file name based on the other file name.

In contrast, when determining that the file name to be determined is unused (i.e., that the corresponding piece of file name use status information is “0”), the file name use status determining unit 21 rewrites “1” into the corresponding piece of file name use status information. In this case, the file name use status determining unit 21 enables the storage access unit 11 and a file management information adding unit 12. As a result, the storage access unit 11 stores the file in the storage unit 30. The storage access unit 11 further notifies information including the file name and size of the file, the date of creating the file, the position where the file is stored (e.g., a cluster number when the storage unit 30 is a hard disk), file attributes, and other descriptions to the file management information adding unit 12.

The file management information adding unit 12 adds the information notified thereto from the storage access unit 11, as file management information used to manage the file stored in the storage unit 30, to the file management information array 13. The file management information array 13 and the file management information can be the same as the aforementioned ones as explained in Embodiment 1 or 2. When adding the file management information to the file management information array 13, the file management information adding unit 12 creates an index from the file name by using a function representing a one-to-one correspondence between file names and indexes. The function used can be either the function f explained in Embodiment 1 or the function f1 explained in Embodiment 2, or can be a function of another type. The file management information adding unit 12 adds the file management information about the file to the position specified by the index within the file management information array 13. As an alternative, the file management information adding unit 12 can add the file management information about the file to the position specified by the index created by the index creating unit 24 within the file management information array 13.

On the other hand, when trying to make the electrical equipment read a file, the user specifies the file's name by using a man-machine interface not shown in the figure. The file name is then notified to the index creating unit 14. It can be assumed that this notification about the file name is also an inquiry about whether or not the file name of the target file to be read has already been used in the storage unit 30. In response to the notification about the file name, the index creating unit 14 creates an index from the file name by using a function representing a one-to-one correspondence between file names and indexes, and then notifies the index to the file name use status determining unit 23.

When receiving the index, the file name use status determining unit 23 determines what use status a piece of file name use status information corresponding to the index received from the index creating unit 14 indicates within the file name use status information array 22 by referring to the file name use status information array 22.

When determining that the file name to be determined is unused (i.e., that the corresponding piece of file name use status information is “0”), the file name use status determining unit 23 generates and outputs a signal indicating “The requested file does not exist”. The man-machine interface not shown of the electrical equipment can urge the user to specify another file name in response to the signal indicating “The requested file does not exist”. For example, a display or speaker is made to display or speak “There is no file that corresponds to the file name. Please specify another file name.” so as to urge the user to specify another file name. Then the user specifies another file name, and the index creating unit 14 and the file name use status determining unit 23 repeatedly carry out the process of determining the use status of the other file name based on the other file name.

In contrast, when determining that the file name to be determined has already been used (i.e., that the corresponding piece of file name use status information is “1”), the file name use status determining unit 23 notifies the index to an index and file management information associating unit 15.

The index and file management information associating unit 15 reads a piece of file management information corresponding to the target file from the position specified by the index within the file management information array 13, and notifies the piece of file management information to a read access unit 16. The read access unit 16 reads the target file from the storage unit 30 by using a description included in the piece of file management information and indicating the position where the target file is stored in the storage unit 30. Thus the electrical equipment can provide the target file for its intended use.

As mentioned above, in accordance with this embodiment 3, the following advantages are provided in addition to the same advantages as offered by embodiment 1 or embodiment 2. In other words, when newly storing a file in the storage unit 30, in response to an inquiry about whether or not the file name of the target file has already been used in the storage unit 30, the index creating unit 24 creates an index from the file name of the target file by using a function representing a one-to-one correspondence between file names and indexes. The file name use status determining unit 21 then reads a corresponding piece of file name use status information from the file name use status information array 22 by using the index, and determines whether or not the file corresponding to the file name to be inquired has already been stored in the storage unit 30.

Thus, when trying to newly store a file in the storage unit 30, the file name use status determining unit 21 can determine whether or not a file name given to the file by the user has already been used in the storage unit 30 (i.e., whether or not the file having the file name has already stored in the storage unit 30). Therefore the user can promptly take appropriate measures, such as giving another file name to the file, according to the determination result. For example, when the electrical equipment to which this embodiment is applied is an apparatus for storing music, moving pictures and sounds, or image files (i.e., an apparatus capable of recording sounds or images), the electrical equipment can promptly determine the file name of a target sound or image file to be recorded, thus providing high utility.

In the file name use status information array 22, plural pieces of file name use status information, each of which indicates whether or not a corresponding file specified by a file name has already been stored in the storage unit, are aligned in ascending order of corresponding indexes. In other words, each index indicates the position where a corresponding one of file name use status information about the target file is stored within the file name use status information array 22. Therefore, the electrical equipment can acquire the file name use status information about the target file at once based on the index without searching through the file name use status information array 22. In addition, because the electrical equipment uses the function f representing a one-to-one correspondence between file names and indexes, it can prevent creation of an indeterminate index from a corresponding file name and a collision between a created index and any other index. Furthermore, as mentioned above, because the electrical equipment uses the simple function of assigning a part of the file name extracted from the file name to an index, just as it is, the load on the processor 10 can be reduced.

Even when trying to read a file having an input file name, in response to an inquiry about whether or not the input file name of the target file to be read has already been used in the storage unit 30, the file name use status determining unit 23 reads a corresponding piece of file name use status information from the file name use status information array 22 by using an index created by the index generation unit 14, and then determines whether or not the target file to be read corresponding to the file name has already been stored in the storage unit 30. When thus trying to read a file having an input file name from the storage unit 30, because the file name use status determining unit 23 can determine whether or not the input file name has already been used (i.e., whether or not the file having the file name has already been stored in the storage unit 30), the user can promptly take appropriate measures, such as reading of a file having another file name, according to the determination result.

Embodiment 4.

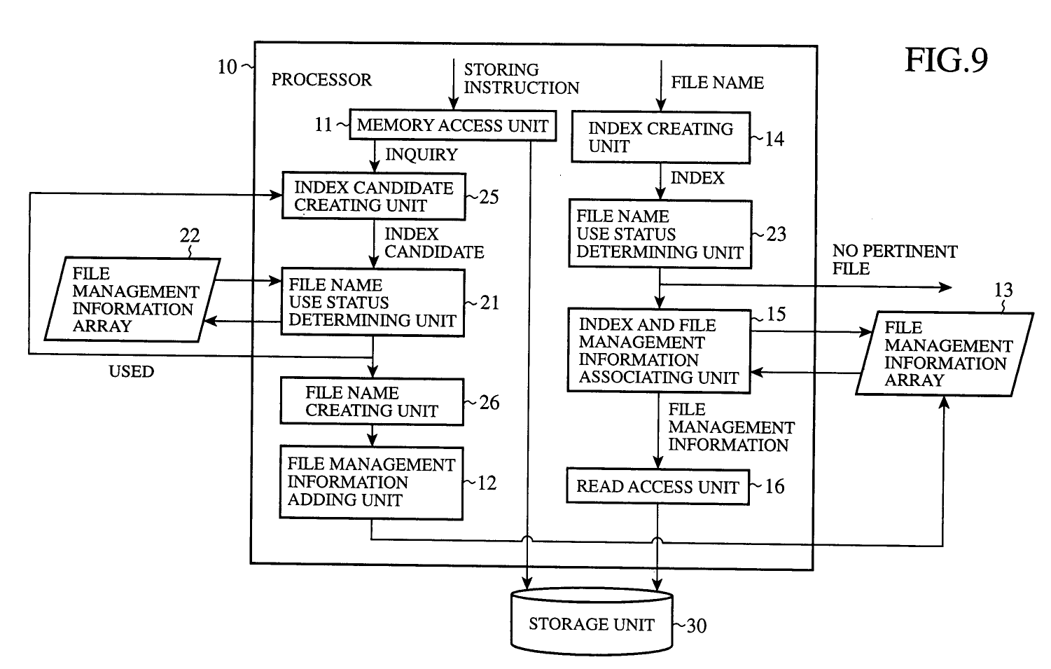

FIG. 9 is a block diagram showing a part of electrical equipment provided with a file management apparatus according to embodiment 4 of the present invention. A processor 10 that is the file management apparatus of FIG. 9 differs from the processor 10 of embodiment 3 as shown in FIG. 7 in that the processor 10 of embodiment 4 doesn't include an index creating unit 24, but includes an index candidate creating unit 25 and a file name creating unit 26. In the electrical equipment of this embodiment, when newly storing a file in a storage unit 30, the processor 10 automatically creates the file's name.

Next, an operation of this processor 10 will be explained. The processor 10 carries out the following operation according to a software program. When a user tries to make the electrical equipment read a file, an index creating unit 14, a file name use status determining unit 23, an index and file management information associating unit 15, and a read access unit 16 work in the processor 10, like those of embodiment 3. The electrical equipment carries out this file reading operation in the same way that that of above-mentioned embodiment 3 does, and therefore the explanation of the file reading operation will be omitted hereafter.

On the other hand, in response to a storing instruction from a user to store a file which is created by the electrical equipment or which is retrieved into the electrical equipment from outside the electrical equipment, a storage access unit 11 creates an inquiry about the file name of an unstored file that is not stored in the storage unit 30 (i.e., an inquiry about an unused file's name), and sends this inquiry to the index candidate creating unit 25.

In response to this inquiry, the index candidate creating unit 25 creates an index candidate and notifies the index candidate to a file name use status determining unit 21. For example, the index candidate creating unit 25 creates an index candidate “0” immediately after receiving the inquiry from the storage access unit 11.

When receiving the index candidate, the file name use status determining unit 21 determines what use status a piece of file name use status information corresponding to the index candidate received from the index candidate creating unit 25 indicates within a file name use status information array 22 by referring to the file name use status information array 22. The file name use status information array 22 is the same as that mentioned in Embodiment 3. When the file name use status information is “1”, it indicates that a corresponding file name has already been used (i.e., a file having the file name has already been stored in the storage unit 30). When the file name use status information is “0”, it indicates that the corresponding file name is unused (i.e., no file having the file name exists in the storage unit 30).

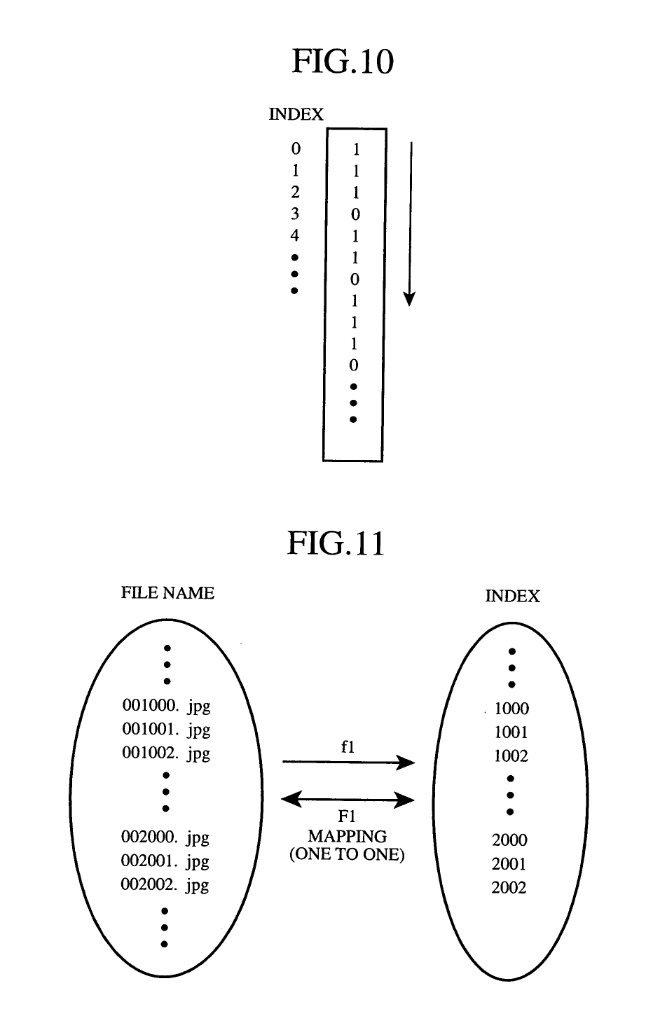

When determining that the file name to be determined corresponding to the index candidate has already been used (i.e., that the corresponding piece of file name use status information is “1”), the file name use status determining unit 21 generates a signal indicating “used” and delivers this signal to the index candidate creating unit 25. When receiving this signal indicating “used”, the index candidate creating unit 25 creates the next index candidate (e.g., “1”), and notifies the next index candidate to the file name use status determining unit 21. Thus, the index candidate creating unit 25 creates index candidates successively until an unused file name is found out, and the file name use status determining unit 21 repeats the process of determining the use status of the created file name. In other words, as shown in FIG. 10, the file name use status determining unit 21 starts from the first numerical value “0” that can be an index and then scans all index candidates sequentially in ascending order of numbers represented by corresponding indexes. In the example of FIG. 10, the file name use status information corresponding to the fourth index candidate “3” is “0” and represents an unused file's name.

The file name use status determining unit 21 rewrites “1” into the corresponding piece of file name use status information when determining that the file name to be determined corresponding to the index candidate is unused (i.e., that the corresponding piece of file name use status information is “0”). In this case, the file name use status determining unit 21 enables the storage access unit 11 and the file name creating unit 26. As a result, the storage access unit 11 stores the file in the storage unit 30. The storage access unit 11 further notifies information including the size of the file, the date of creating the file, the position where the file is stored (e.g., a cluster number when the storage unit 30 is a hard disk), file attributes, and other descriptions to a file management information adding unit 12.

Furthermore, the file name creating unit 26 creates the file's name based on the index candidate associated with the unused file name by using a function representing a one-to-one correspondence between file names and indexes (i.e., index candidates). Concretely, by applying the inverse of the function, which the index creating unit 14 uses to create an index at the time of reading a file, to the index candidate, the file name creating unit 26 creates an unused file's name.

For example, when the index creating unit 14 uses the function f1 as shown in FIG. 11 so as to create an index from a file name, the file name creating unit 26 acquires an unused file's name by using the inverse function F1. The function used to create an index from a file name can be either the function f as explained in Embodiment 1 or the function f1 as explained in Embodiment 2, or can be a function of another type. In this embodiment, because the electrical equipment automatically creates an index candidate and acquires an unused file name, the electrical equipment cannot specify a directory according to a user's intention, unlike that of embodiment 2.

The file name creating unit 26 notifies the created unused file's name to the file management information adding unit 12. The file management information adding unit 12 adds the information notified thereto from the storage access unit 11 and the file name creating unit 26, as a piece of file management information used for managing the file stored in the storage unit 30, to the file management information array 13. The file management information array 13 and the piece of file management information can be the same as those mentioned in Embodiment 1 or Embodiment 2. When adding a piece of file management information to the file management information array 13, the file management information adding unit 12 creates an index from a corresponding file name by using a function representing a one-to-one correspondence between file names and indexes. The function used can be either the function f as explained in Embodiment 1 or the function f1 as explained in Embodiment 2, or can be a function of another type. The file management information adding unit 12 then adds file management information about a file to the position specified by the index within the file management information array 13. As an alternative, the file management information adding unit 12 can add the file management information about the file to the position specified by the index created by the index creating unit 24 within the file management information array 13.

As mentioned above, in accordance with this embodiment 4, the index candidate generation unit 25 creates index candidates successively in response to an inquiry about the file name of an unstored file not stored in the storage unit 30 (i.e., an inquiry about an unused file's name), and the file name creating unit 26 creates an unused file's name from an index candidate, which has been determined, by the file name use status determining unit 21, to have a corresponding file name that is unused in the storage unit 30, by using a function representing a one-to-one correspondence between file names and indexes. As a result, when newly storing a file in the storage unit 30, the electrical equipment can automatically the file's name. For example, when the electrical equipment to which this embodiment is applied is an apparatus for storing music, moving pictures and sounds, or image files (i.e., an apparatus capable of recording sounds or images), the electrical equipment can promptly determine the file name of a target sound or image file to be recorded, thus providing high utility.

Furthermore, as mentioned above, when the electrical equipment uses the simple function of assigning a part of the file name extracted from the file name to an index, just as it is, the file name generation unit 26 can use a simple inverse function of creating an unused file's name by adding characters to the index. Therefore, the load on the processor 10 can be reduced.

Many widely different embodiments of the present invention may be constructed without departing from the spirit and scope of the present invention. It should be understood that the present invention is not limited to the specific embodiments described in the specification, except as defined in the appended claims.

What is claimed is:

1. A file management apparatus comprising:
an index creating unit for creating an index indicating file management information that specifies a position where a target file to be read is stored in a storage unit from the target file's name by using a function representing a one-to-one correspondence between file names and indexes; and
a storage access control unit for, to read the target file to be read from said storage unit, reading a piece of file management information corresponding to the index created by said index creating unit from a series of pieces of file management information in which plural pieces of file management information are aligned in order of corresponding indexes, and for acquiring a position where the target file to be read specified by the read piece of file management information is stored in said storage unit.

2. The file management apparatus according to claim 1, wherein said index creating unit comprises: a first extracting unit for extracting a first portion representing a directory in which the target file to be read is stored from the file name specifying the target file to be read, the file name, as well as the file itself, being created according to a method of representing the directory for the file; a first creating unit for creating a base position of the directory from the first portion by using a function representing a one-to-one correspondence between first portions and directory base positions; a second extracting unit for extracting a second portion specifying the file itself from the file name; a second creating unit for creating an index element from the second portion by using a function representing a one-to-one correspondence between second portions and index elements; and a combining unit for combining the base position and the index element so as to create the index.

3. The file management apparatus according to claim 1, wherein said index creating unit extracts a portion from the target file's name and defines it as the index just as it is.

4. The file management apparatus according to claim 1, further comprising: a second index creating unit, responsive to an inquiry about whether or not a file having a specified file name has already been used in said storage unit, for creating an index from the specified file name by using a function representing a one-to-one correspondence between the file name and the index; and a file name use status determining unit for reading a piece of file name use status information about the specified file name from a file name use status information array, in which a plurality of pieces of file name use status information each indicating whether or not a file specified by a corresponding file name has already been stored in said storage unit are aligned in order of corresponding indexes, by using the index created by said second index creating unit so as to determine whether or not a file having the specified file name has already been stored in said storage unit.

5. The file management apparatus according to claim 1, further comprising: an index candidate creating unit for successively creating an index candidate in response to an inquiry about whether or not a specified file name is a file name unused in said storage unit; a file name use status determining unit for reading a piece of file name use status information corresponding to the index candidate created by said index candidate creating unit from a file name use status information array, in which a plurality of pieces of file name use status information each indicating whether or not a file specified by a corresponding file name has already been stored in said storage unit are aligned in order of corresponding indexes, so as to determine whether or not a file name corresponding to the index candidate has already been used in said storage unit; and a file name creating unit for creating an unused file's name from an index candidate, which has been determined, by said file name use status determining unit, to have a corresponding file name that is unused in said storage unit, by using a function representing a one-to-one correspondence between the file name and the index candidate.

6. The file management apparatus according to claim 5, wherein said file name creating unit creates the unused file's name by applying an inverse of the function which said index creating unit uses so as to create the index to the index.
